(19) United States
(12) Patent Application Publication
(10) Pub. No.: US 2012/0189901 A1
(43) Pub. Date: Jul. 26, 2012

(54) BATTERY CELL, BATTERY MODULE INCORPORATED WITH SAME AND METHOD FOR PRODUCING THE BATTERY MODULE

(76) Inventor: Chia-Ming Chuang, Taipei City (TW)

(21) Appl. No.: 13/171,442

(22) Filed: Jun. 29, 2011

Related U.S. Application Data
(60) Provisional application No. 61/435,245, filed on Jan. 21, 2011.

(51) Int. Cl. H01M 2/24; H01M 2/02; B23K 31/02; H01M 2/00

(52) U.S. Cl. 429/158; 429/163; 429/164; 228/179.1

(57) ABSTRACT

The invention relates to a battery cell provided on its peripheral side surface, instead of on its bottom surface, with a welding zone for connection to a metal strip. The invention also relates to a method for linking multiple battery cells in parallel or in series into a battery module, with spot welding connections to the positive and negative terminals not on opposite ends to improve production flow. Over current protection device is incorporated to form a compact battery module with internal over current protection.

### CROSS-REFERENCE TO RELATED APPLICATIONS

This application claims the benefit of U.S. Provisional Application 61/435,245 filed on Jan. 21, 2011, the teachings of which are incorporated herein by reference.

### FIELD OF THE INVENTION

The present invention relates to a battery cell, a battery module incorporated with the battery cell, and a method for producing the battery module. The invention also relates to rechargeable battery systems for energy-conserving electric and hybrid vehicles, grid storage systems, or notebook computers, and more specifically to systems for interconnecting battery cells.

### DESCRIPTION OF THE RELATED ART

Given the risk of increasing carbon emissions when using a pollution-generating energy source with limited reserves, such as fossil oil and natural gas, the high-tech industry is now pursuing replacement of the traditional energy sources with renewable and clean energy sources, including solar energy, hydraulic energy and wind energy. With this trend, electric-powered vehicles have become a research hotspot in the related fields. The development of electric-powered vehicles, however, is limited by the need for efficient batteries to provide an enormous quantity of electrical energy for motor driving. In addition, motor vehicles for transportation use must pass strict environment tests and meet the crash safety standards. Therefore, connecting batteries in a safer way, maximizing the energy stored in batteries, prolonging the endurance of batteries and protecting batteries from burning and explosion in case of accident are key issues for developing the equipments of this type.

Multiple conventional rechargeable batteries such as Lithium-ion or Nickel metal hydride batteries may be arranged in series or parallel to obtain any desired voltage or current. For example, a set of batteries may be arranged in parallel by connecting their positive electrodes to one conductor, and connecting their negative electrodes to another conductor, thus forming a battery module with much larger current capabilities. Said battery module can be connected in series to obtain a desired voltage, higher than the individual cell capabilities.

One of the most popular form factors for rechargeable batteries is that of cylindrical shape, with positive electrode on one end, and negative electrode on the other end. A typical construction is shown in FIG. 1. The battery cell, 101, has a positive electrode 102 on top, and the negative electrode 104 that is also the outer metal casing for the battery cell, 101. The positive electrode 102 and negative electrode 104 are separated at the top by an insulating gasket. An insulating cover typically made of plastic material, 103, is applied on the outside of the battery, exposing the positive electrode 102 at the top and the negative electrode 104 at the bottom. Typical connection is to spot welding a metal strip 108 to the positive electrode 102 at the top and to spot welding a separate metal strip 109 to the negative electrode 104 at the bottom. The production process for connection battery cells together requires two separate steps: holding and positioning the battery cells from the bottom and spot welding a metal strip to the top terminals, and then holding and positioning the battery cells from the top, and executing spot welding another metal strip to the bottom terminals. Furthermore, connecting two battery cells in series is more difficult than connection in parallel, since the bottom terminal of one cell need to be connected to the top terminal of a second cell, and the terminals are located at opposite ends. As shown in FIG. 3a, parallel connection requires spot welding a metal strip 108, to terminals 102, 112, and 122 together, and to spot welding a second metal strip 109, to terminals 104, 114, and 124 together. As shown in FIG. 3b, serial connection requires spot welding a metal strip 118, from terminal 102 to terminal 134, and a second metal strip 119 from terminal 132 to terminal 144. It is difficult to execute serial connections in production when the same metal strip must go from the top of one cell to the bottom of another cell. Common industrial practice is to limit serial connection to vertical stacking of battery cells, a limitation severely constraint the form factor of battery modules. It is desirable to find better module constructions that simplify parallel and serial connections, also provide more degrees of freedom in module form factor.

A problem with direct connection of battery cells is the lack of short circuit protection. For parallel connection of battery cells, if a single battery developed internal short circuit, either due to malfunction, damage, or process defects, adjacent connected battery cells would try to channel current to the shorted cell, and quickly drain out all the charges, pulling all connected cells into over discharge, and render the entire parallel connected battery module not operative. Furthermore, this inrush current into the shorted cell could lead to overheat and explosion, creating a catastrophic event.

For serial connection of battery cells, if an external short circuit is developed, either due to a metal object dropped onto the battery module, or a severe impact event that physically shorted connecting wires or terminals, battery cells across this short circuit path will produce significant current until all the stored energy are depleted. Original terminal voltage across several serial connections is higher than parallel connections, and the total amount of energy is higher, probability of overheat, electric arcing, and explosion are likely.

A typical lithium-ion cylindrical cell, denoted as 18650 cell, has the dimension of 18 mm diameter and 65 mm length. Spot welding to the 18 mm circular area on the positive electrode 102, and the negative electrode 104, in FIG. 1, is a challenge in production. Tesla Motors' Roadster uses more than 6,800 of the 18650 cells in its battery pack. Making all spot welding joints robust and can withstand the shock and vibration experienced by the vehicle is a significant challenge in production.

Therefore, there exists a need for an improved battery cell and a method of connection of multiple battery cells into a module that can facilitate the productivity and help prevent either internal or external short circuit from causing the module to fail. The present invention provides a feasible solution in response to the need.

### SUMMARY OF THE INVENTION

Accordingly, a purpose of the present invention is to provide a battery cell formed with a welding zone on its negative electrode for connection to a conducing metal strip, wherein the welding zone is relocated from the bottom end to the peripheral side surface of the battery cell, so as to allow for easier serial and parallel configuration. Preferably, the welding zone is extended to create a larger surface area for spot welding to an extent, for example, that the welding zone has a surface area greater than that of the bottom end, thereby enhancing the production yield for connecting multiple battery cells in series or in parallel and further facilitating heat dissipation from the battery cell to the environment.

Another purpose of the invention is to provide a battery module incorporated with multiple battery cells described above, which has a simple structure with low manufacture cost. Preferably, the metal strips for connecting the battery cells are so widened as to reduce metal strip to negative electrode contact resistance. Preferably, the respective metal strips include a narrowed weakened region to serve as short circuit protection device.

It is still another purpose of the invention to provide a method for producing a battery module incorporated with multiple battery cells described above. The method is generally carried out by holding the battery cells from the bottom and connecting the positive and negative electrodes in series or in parallel to form a battery module, thereby providing a significantly efficient manufacture process for achieving parallel or serial connections of battery cells.

The present invention therefore provides a battery cell, which comprises: an elongated body having two opposite first and second ends and a surrounding sidewall extending therebetween, wherein the first end is formed with a positive electrode, and wherein the surrounding sidewall and the second end constitute a negative electrode electrically insulated from the positive electrode; and an outer insulating cover covering over the surrounding sidewall, wherein the outer insulating cover is omitted in part to define an omitted portion that exposes at least a part of the surrounding sidewall located away from the second end, so that the part of the surrounding sidewall forms a welding zone.

The invention further provides another battery cell, which comprises: an elongated body having two opposite first and second ends and a surrounding sidewall extending therebetween, wherein the first end is formed with a positive electrode, and wherein the surrounding sidewall and the second end constitute a negative electrode electrically insulated from the positive electrode, and wherein the negative electrode has a contact portion extending therefrom towards the first end; and an outer insulating cover covering over at least a part of the negative electrode in such a manner that the contact portion is exposed to form a welding zone.

The invention also relates to a battery module provided with battery cells. The battery module comprises: a first and a second battery cells extending along a longitudinal direction, each comprising: an elongated body having two opposite first and second ends and a surrounding sidewall extending therebetween, wherein the first end is formed with a positive electrode, and wherein the surrounding sidewall and the second end constitute a negative electrode electrically insulated from the positive electrode; and an outer insulating cover covering over the surrounding sidewall, wherein the outer insulating cover is omitted in part to define an omitted portion that exposes at least a part of the surrounding sidewall located away from the second end, so that the part of the surrounding sidewall forms a welding zone; one or more metal welding strips that connect the first and second battery cells in series by connecting the positive electrode of the first battery cell to the welding zone of the second battery cell, or connect the first and second battery cells in parallel by connecting the positive electrodes of the first and second battery cells with each other and connecting the welding zones of the first and second battery cells with each other.

The invention further relates to a method for producing a battery module, comprising assembling a first and a second battery cells into a battery module, the first and a second battery cells extending along a longitudinal direction and each comprising an elongated body and an outer insulating cover, wherein the elongated body has two opposite first and second ends and a surrounding sidewall extending therebetween, wherein the first end is formed with a positive electrode the surrounding sidewall and the second end constitute a negative electrode electrically insulated from the positive electrode and wherein the outer insulating cover covers over the surrounding sidewall, wherein the outer insulating cover is omitted in part to define an omitted portion that exposes at least a part of the surrounding sidewall located away from the second end, so that the part of the surrounding sidewall forms a welding zone, the method comprising:

a) positioning the first and second battery cells in parallel along an arrangement direction traversing the longitudinal direction at a first predetermined angle, and aligning the omitted portions of the outer insulating covers of the first and second battery cells in a direction intersecting the arrangement direction at a second predetermined angle;

b) providing one or more metal welding strips, each being provided with at least one weakened portion having a cross-sectional area substantially smaller than the remaining portion of the metal welding strip; and

c) welding the metal welding strips to the first and second battery cells in such a manner that the first and second battery cells are electrically connected in series by connecting the positive electrode of the first battery cell to the welding zone of the second battery cell, or the first and second battery cells are electrically connected in parallel by connecting the positive electrodes of the first and second battery cells with each other and connecting the welding zones of the first and second battery cells with each other.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a side view of a conventional cylindrical battery cell;

FIG. 2 is a side view of a modified cylindrical battery cell according to the first preferred embodiment of the invention;

FIG. 3a is a side view of the conventional battery cells connected in parallel;

FIG. 3b is a side view of conventional battery cells connected in series;

FIG. 4a is a side view of inventive battery cells connected in parallel according to the second preferred embodiment of the invention;

FIG. 4b is a side view of inventive battery cells connected in series according to the second preferred embodiment of the invention; and

FIG. 5 is a schematic diagram showing a battery cell according to the third preferred embodiment of the invention.

### DETAILED DESCRIPTION OF THE INVENTION

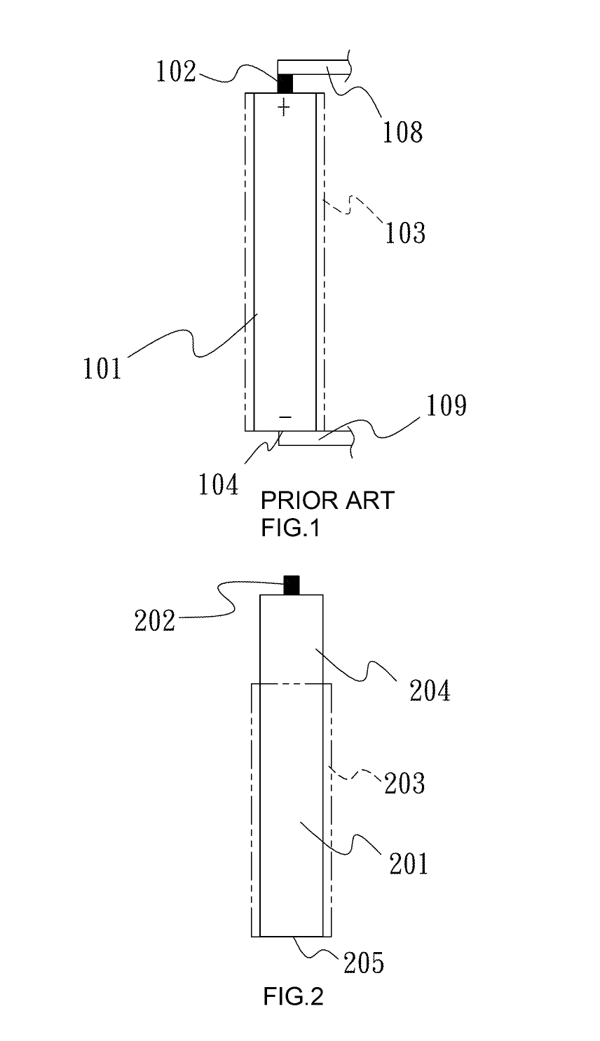

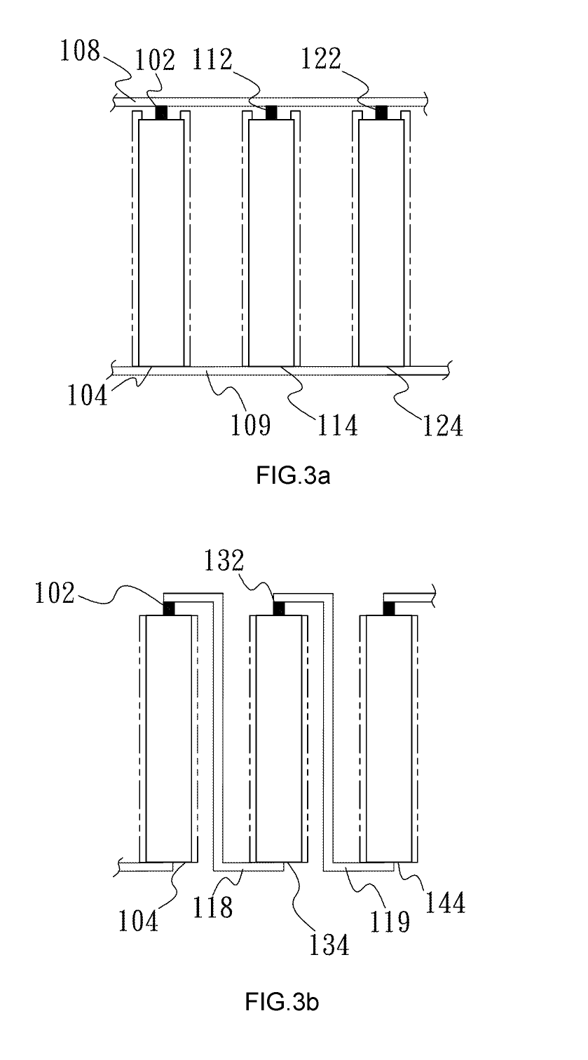

FIG. 1 is a side view of a conventional cylindrical battery cell 101. A thin plastic insulating sheet 103, covers most of the outer metal casing, which is also a part of the negative electrode 104, so that the negative electrode 104 can only be accessed from the bottom of the cell. FIG. 2 is a side view of a battery cell 201, according to the first embodiment of the invention. The battery cell 201 includes two opposite ends 202, 205 and a surrounding sidewall extending between the two ends to constitute an elongated body. The outer surface of the surrounding sidewall is defined herein as a peripheral side surface of the elongated body. In the case of a cylindrical-shaped battery cell, the peripheral side surface is formed by the points at a fixed distance from the longitudinal axis of the cylindrical-shaped body, which is defined herein as a radial side surface of the body. Among the two opposite ends, the top end 202 constitutes a positive electrode, whereas the bottom end 205 together with the surrounding sidewall constitute a negative electrode electrically insulated from the positive electrode. According to this embodiment, the thin plastic insulating sheet 203 is cut away near the top, exposing a part of the negative electrode 204 for connection to a metal strip. In the case of a cylindrical-shaped battery cell, the cut-away portion is formed with respect to the radial side surface of the elongated body, so that a part of the surrounding sidewall remote from the bottom end 205 is exposed to form a welding zone for connection to a metal strip. In one embodiment, the plastic insulating sheet 203 is girdled all the way around the perimeter of the cylindrical-shaped, elongated body 201, so as to expose a part of the surrounding sidewall remote from the bottom end 205. In another embodiment, only a portion of the plastic insulating sheet 203 around the around the perimeter of the cylindrical body 201 is removed.

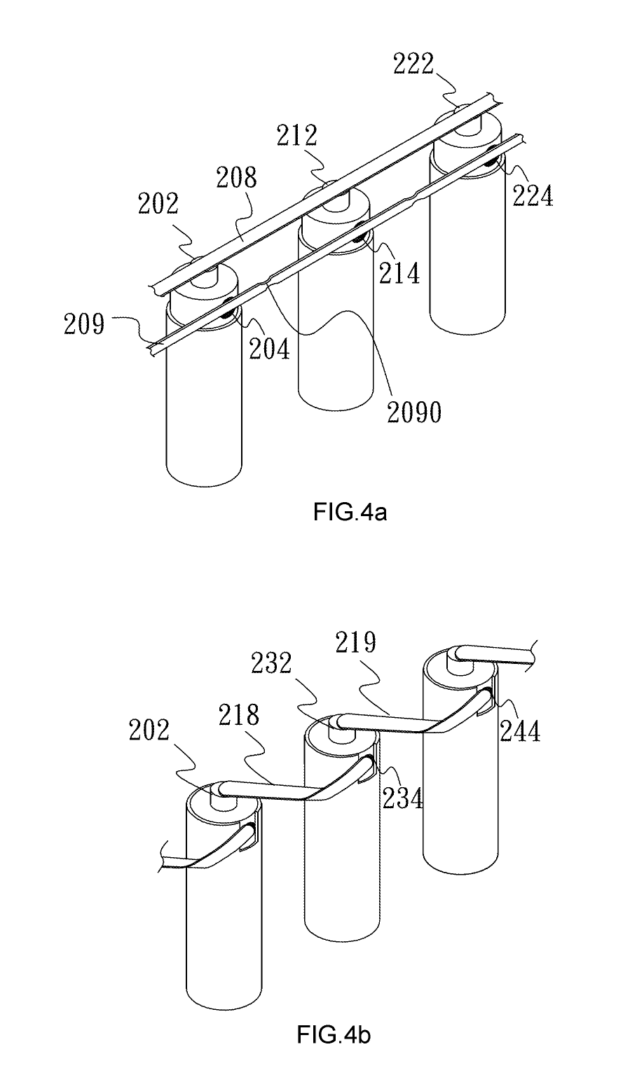

FIG. 4a shows the physical connection of three cells in parallel. A metal strip 208, typically made out of a thin nickel sheet, is spot welded to 3 positive electrodes, 202, 212, 222 located on three battery cells, respectively. A separate metal strip 209 is spot welded to 3 negative electrodes 204, 214, 224. Typical thickness of the nickel sheet is between 0.1 mm to 0.3 mm. Preforming the nickel sheet to the cylindrical curvature of the cell is a known process in the industry. Spot welding of such nickel sheet to the side wall of the cell is a simple process.

FIG. 4b shows the physical connection of three cells in series. A metal strip 218, typically made out of thin nickel sheet, is spot welded to the first positive electrode 202, and twisted and preformed to spot welded to the second cell negative electrode 234. A separate metal strip 219 is spot welded to the second positive electrode 232, and twisted and preformed to be spot welded to the third cell negative electrode 244. Typical metal strip is based on nickel with a thickness of 0.1 mm to 0.3 mm, so twisting and forming is relatively easy. By holding battery cells from the bottom, both parallel and serial connections can be made to both positive and negative electrodes to form a battery module, a significant advancement over prior art.

The battery cells are arranged in parallel along a direction which is defined herein as an arrangement direction. Preferably, the arrangement direction is perpendicular to the longitudinal direction which the longitudinal axes of the battery cells extend, so as to produce a compact battery module. The cut-away portions of the outer insulating covers of the battery cells are preferably oriented to face the same direction, so as to allow for easier serial and parallel connections. More preferably, the cut-away portions are aligned in a direction intersecting the arrangement direction at a predetermined angle, which is preferably but not necessarily 0 degree.

The cutting of the plastic cover to expose the negative electrode can be performed as the last step of the cell production process, or can have perforated holes formed along the cut out area in the cell production process, and strip off as the first part of the battery module production process. As an alternative, the plastic cover is applied onto the surrounding sidewall of the battery cell during the cell production process in such a manner that the surrounding sidewall is not covered by the plastic cover near the top end. While one can order battery cells from vendor without this plastic cover, handling cells without insulation protection is burdensome because any contact with metal object may lead to short circuit.

In one preferred embodiment of the invention, the welding zone 204 is lengthened to create a larger area for spot welding, with a corresponding yield increase in production. In a more preferred embodiment, the welding zone 204 has a surface area greater than that of the bottom end 205.

Meanwhile, removing heat generated in either charging or discharging of current from the battery is a difficult task. Too high of a battery cell temperature could lead to shorter life span, and in extreme cases, lead to destruction of the cell, thermal event, or explosion. A conventional battery cell as shown in FIG. 1 has most of the exterior covered by the plastic material 103. Most plastic material has good electrical insulation properties as well as thermal insulation properties. However, such plastic insulation would seriously reduce heat dissipation from the battery cell to the environment. According to the preferred embodiment shown in FIG. 4a, the invention can have the exposed welding zones 204, 214, and 224 spot welded to a metal strip 209, with significant heat removal capabilities over plastic insulation, and the battery module constructed with the preferred embodiment of the invention having cooler temperature, longer cell life and higher margin of safety.

There are many spot welding technologies based on either laser, ultrasound, or resistive heating principles. In all spot welding technologies, there is a limit on the thickness of the metal strip before spot welding yield started to decline. That is, a metal strip having a thickness of more than 0.3 mm will be easily overheated and collapsed during welding and is generally considered unsuitable for the purposes described herein. A typical limit is 0.3 mm for spot welding of 18650 cells. The electrical resistance of the metal strip in a battery module is a burden to the operation, since energy passing through it is lost as heat. Furthermore, it exacerbates the heat removal problem for battery operation. In a preferred embodiment of the invention as shown in FIG. 4a, the metal strip 209, connecting welding zones 204, 214, 224, is widened to form more spot welding joints to reduce metal strip to negative electrode contact resistance. The widening of the metal strip also lowers electrical resistance.

On at least some of the conducting metal strips, there is a narrowed and weakened region 2090 to serve as short circuit protection. Said narrowed and weakened region allows expected current to pass through without significant heating, while allowing the narrowed region to break in an overcurrent condition, such as would be expected during a short circuit. In an overcurrent condition, the narrowed region will break sufficiently to ensure that no arcing will occur at the voltage expected in a worst case short, such as a short between the first conductor and the last conductor in the series of smaller sets. Said narrowed region can be of different width and shape based on different voltage and current fusing requirements. In one embodiment, said narrowed region has a cross-sectional area substantially smaller than the remaining portion of the metal welding strip. In one embodiment, said narrowed region is only applied to either the positive electrode or negative electrode connection and not on both terminals to be effective, as those skilled in the relevant art would know. In another embodiment, said narrowed and weakened region is applied to both of the positive and negative electrode connections.

For a battery module that is constructed of parallel subgroup of battery cells before the subgroups are connected in series, the narrowed region that served as a fuse in serial connections can be located in an externally accessible location and will be blown at a lower current level than the sum of the operating current in each subgroup, to help ensure that the serial fuse will blow before the parallel connection ones in the event of an external short circuit, making it easy to repair this condition by reconnecting the externally accessible blown narrowed region, rather than requiring repair of all or some of the fuses within the paralleled subgroup.

The battery module disclosed herein is suitable for use as a power source for any apparatus that requires electric power to operate, and particularly suitable for energy-conserving electric and hybrid vehicles, grid storage systems, or notebook computers, and more specifically to systems for interconnecting battery cells.

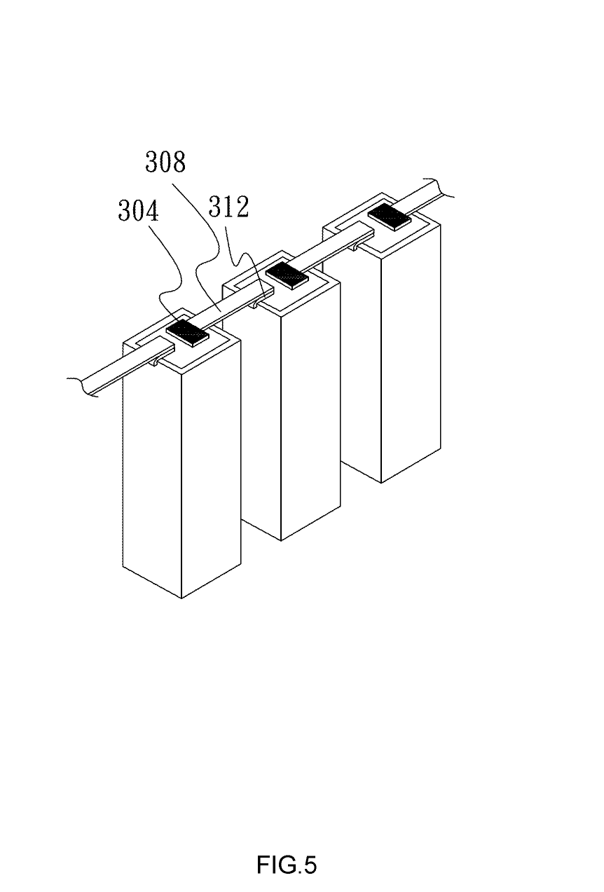

According to the third preferred embodiment of the invention shown in FIG. 5, a battery cell 301 is tailored to have the same configuration as described in the first embodiment above, except that a contact portion is provided to extend from the negative electrode, preferably from the surrounding sidewall, towards the top end of the battery cell. The contact portion is exposed through the outer insulating cover covering over the negative electrode and constitutes a welding zone 304 for connection to a metal strip 308. The metal strip 308 is in turn connected to a positive electrode 312 of an adjacent battery cell. By virtue of this arrangement, multiple battery cells can be easily connected in series.

It should be apparent to those skilled in the relevant art that the invention can be extended to include prismatic battery cells, the only differences is in the shape of the battery cell. For larger format cells, the cell construction has negative electrode metal surface on the top surface. In this case, it should also be apparent to those skilled in the relevant art that the invention can be extended to include cell terminal relocation to the top surface.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A battery cell comprising:
an elongated body having two opposite first and second ends and a surrounding sidewall extending therebetween, wherein the first end is formed with a positive electrode, and wherein the surrounding sidewall and the second end constitute a negative electrode electrically insulated from the positive electrode; and
an outer insulating cover covering over the surrounding sidewall, wherein the outer insulating cover is omitted in part to define an omitted portion that exposes at least a part of the surrounding sidewall located away from the second end, so that the part of the surrounding sidewall forms a welding zone.

2. The battery cell according to claim 1, wherein the welding zone has a surface area greater than that of the second end.

3. The battery cell according to claim 1, wherein the elongated body is cylindrical-shaped.

4. The battery cell according to claim 3, wherein the omitted portion is formed on a peripheral side surface of the elongated body.

5. A battery module incorporated with battery cells, comprising:
a first and a second battery cells extending along a longitudinal direction, each comprising:
an elongated body having two opposite first and second ends and a surrounding sidewall extending therebetween, wherein the first end is formed with a positive electrode, and wherein the surrounding sidewall and the second end constitute a negative electrode electrically insulated from the positive electrode; and
an outer insulating cover covering over the surrounding sidewall, wherein the outer insulating cover is omitted in part to define an omitted portion that exposes at least a part of the surrounding sidewall located away from the second end, so that the part of the surrounding sidewall forms a welding zone;
one or more metal welding strips that connect the first and second battery cells in series by connecting the positive electrode of the first battery cell to the welding zone of the second battery cell, or connect the first and second battery cells in parallel by connecting the positive electrodes of the first and second battery cells with each other and connecting the welding zones of the first and second battery cells with each other.

6. The battery module according to claim 5, wherein the metal welding strips are each provided with at least one weakened portion having a cross-sectional area substantially smaller than the remaining portion of the metal welding strip.

7. The battery module according to claim 6, wherein the metal welding strips are nickel sheets having a thickness of less than 0.3 mm.

8. The battery module according to claim 6, wherein the metal welding strips comprise a positive electrode welding strip interconnecting the positive electrodes of the first and second battery cells with each other and a negative electrode welding strip interconnecting the welding zones of the first and second battery cells with each other.

9. The battery module according to claim 6, wherein the metal welding strips each includes two opposite welding ends, wherein one of the welding ends welded to the positive electrode of the first battery cell and the other welding end welded to the welding zone of the second battery cell.

10. The battery module according to claim 9, wherein the first and second battery cells are arranged in parallel along an arrangement direction traversing the longitudinal direction at a first predetermined angle, and wherein the omitted portions of the outer insulating covers of the first and second battery cells are aligned in a direction intersecting the arrangement direction at a second predetermined angle.

11. A method for producing a battery module, comprising assembling a first and a second battery cells into a battery module, the first and a second battery cells extending along a longitudinal direction and each comprising an elongated body and an outer insulating cover, wherein the elongated body has two opposite first and second ends and a surrounding sidewall extending therebetween, wherein the first end is formed with a positive electrode the surrounding sidewall and the second end constitute a negative electrode electrically insulated from the positive electrode and wherein the outer insulating cover covers over the surrounding sidewall, wherein the outer insulating cover is omitted in part to define an omitted portion that exposes at least a part of the surrounding sidewall located away from the second end, so that the part of the surrounding sidewall forms a welding zone, the method comprising:
a) positioning the first and second battery cells in parallel along an arrangement direction traversing the longitudinal direction at a first predetermined angle, and aligning the omitted portions of the outer insulating covers of the first and second battery cells in a direction intersecting the arrangement direction at a second predetermined angle;
b) providing one or more metal welding strips, each being provided with at least one weakened portion having a cross-sectional area substantially smaller than the remaining portion of the metal welding strip; and
c) welding the metal welding strips to the first and second battery cells in such a manner that the first and second battery cells are electrically connected in series by connecting the positive electrode of the first battery cell to the welding zone of the second battery cell, or the first and second battery cells are electrically connected in parallel by connecting the positive electrodes of the first and second battery cells with each other and connecting the welding zones of the first and second battery cells with each other.
